(19) United States
(12) Patent Application Publication
(10) Pub. No.: US 2015/0208470 A1
(43) Pub. Date: Jul. 23, 2015

(54) LED LIGHT WITH TRIAC-BALLASTED

(71) Applicant: SHANG-KUEI TSAI, Taoyuan County (TW)

(72) Inventor: SHIH-CHIANG LIN, I LAN CITY (TW)

(73) Assignee: SHANG-KUEI TSAI, Taoyuan County (TW)

(21) Appl. No.: 14/157,661

(22) Filed: Jan. 17, 2014

(51) Int. Cl. H05B 33/08

(52) U.S. Cl. CPC H05B 33/0806; H05B 33/0845

(57) ABSTRACT

A LED light with TRIAC ballasted contains a thermistor, Ceramic capacitors, resistors, DIAC, TRIAC, bridge rectifiers, and LED lights, such that after a power supply is conducted, a heat and an impedance of the thermistor change, and then a RC charging/discharging time changes to forward or to lag a phase of the DIAC for triggering the TRIAC, thus lowering the power to stabilize LED brightness or to ballast the LED lights. Since the TRIAC-ballasted LED light is simplified, i.e., electrolytic capacitors, transformers, inductors and chips are eliminated, so a failure rate is much lower than conventional switch-mode drive LED lights. Furthermore, high brightness, long service life, less operating current, lower cost, high reliability are achieved. Preferably, a number of the LED lights is increased or decreased based on required brightness and power voltage.

### FIELD OF THE INVENTION

The present invention relates to a LED light which eliminates switch-mode power transformers and ballasts and drives the LED lights by ways of TRIAC.

### BACKGROUND OF THE INVENTION

An electric circuit for a conventional LED light has short service life so after the electric circuit is broken, the LED lights cannot be driven by the electric circuit to illuminate lights.

A conventional switch-mode drive LED lights contains a switch-mode power driver in which electrolytic capacitors, transformers, inductors and IC are mounted, thus having complicated structure. In addition, after electrolyte of the electrolytic capacitors volatilizes, failure rate is high and EMC/EMI occurs.

The present invention has arisen to mitigate and/or obviate the afore-described disadvantages.

### SUMMARY OF THE INVENTION

The primary object of the present invention is to provide a LED light with TRIAC ballasted which is simplified, i.e., electrolytic capacitors, transformers, inductors and chips are eliminated, so a failure rate is much lower than conventional switch-mode drive LED lights.

Further object of the present invention is to provide a LED light with TRIAC ballasted which achieves high brightness, long service life, less operating current, lower cost, and high reliability.

Another object of the present invention is to provide a LED light with TRIAC ballasted which increases or decreases a number of the LED lights based on required brightness and power voltage.

To obtain the above objective, a LED light with TRIAC ballasted contains: a thermistor, Ceramic capacitors, resistors, DIAC, TRIAC, bridge rectifiers, and LED lights.

The LED lights include a heat sensing module which is comprised of the thermistor and the resistors, and a power conditioning circuit is comprised of the Ceramic capacitors, the resistors, the DIAC, and the TRIAC which are connected together, after the heat sensing module is serially coupled with the bridge rectifiers and the DC LEDs or after the heat sensing module is serially coupled with the AC LEDs, the power conditioning circuit is connected with mains supply.

After conducting power supply, electric current passes through the resistors to produce heat and decrease an impedance of the thermistor, wherein a first Ceramic capacitor connects with the thermistor, and a second Ceramic capacitor couples with the power conditioning circuit so as to enhance capacity in a parallel connecting manner, to prolog RC charging/discharging time, and to lag a phase of the DIAC for triggering the TRIAC, thus lowering the power.

When the power reduces and the electric current passing through the resistors decreases, a lower heat produces and the impedance of the thermistor NTC amplifies, the first Ceramic capacitor connects with the thermistor, and the second Ceramic capacitor parallelly couples with the power conditioning circuit so as to lower the capacity, to shorten the RC charging/discharging time, to forward the phase of the DIAC and to enhance the power, so the power is increased or decreased automatically to stabilize LED brightness or to ballast the LED lights.

The thermistor is adhered on the resistors by ways of a thermal conductive adhesive or is welded on adjacent copper foils by means of a SMD thermistor and a SMD current limiting resistor, such that after the power supply is conducted, the heat and the impedance of the thermistor change, and then the RC charging/discharging time changes to forward or to lag the phase of the DIAC, thus lowering the power to stabilize LED brightness or to ballast the LED lights.

### BRIEF DESCRIPTION OF THE DRAWINGS

FIG. 1 is a circuit diagram of a TRIAC ballasted LED light according to a first embodiment of the present invention.

FIG. 2 is a circuit diagram of a TRIAC ballasted LED light according to a second embodiment of the present invention.

### DETAILED DESCRIPTION OF THE PREFERRED EMBODIMENTS

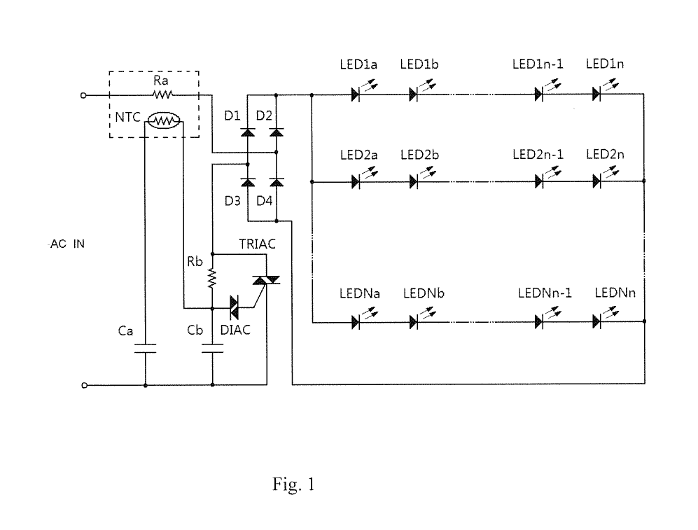

With reference to FIG. 1, a TRIAC-ballasted LED light according to a first embodiment of the present invention comprises: a thermistor, Ceramic capacitors, resistors, DIAC, TRIAC, bridge rectifiers, and DC LED lights.

When a power supply is started, electric currents of the bridge rectifiers (comprises of diodes D1, D2, D3, and D4) and the DC LED lights pass through a heat sensing module (indicated by a square dotted line in FIG. 1) which is comprised of a current limiting resistor Ra and the thermistor NTC, wherein the thermistor NTC is adhered on the current limiting resistor Ra by ways of a thermal conductive adhesive or is welded on adjacent copper foils by means of a SMD thermistor NTC and a SMD current limiting resistor Ra, such that the more electric currents pass through the current limiting resistor Ra, the higher the heat produces, and an impedance of the thermistor NTC becomes small, wherein a first Ceramic capacitor Ca connects with the thermistor NTC, and a second Ceramic capacitor Cb and a resistor Rb couple with a power conditioning circuit (is comprised of the second Ceramic capacitor Cb, the resistor Rb, the DIAC, and the TRIAC) so as to prolong a RC charging/discharging time, and a phase of the DIAC for triggering the

TRIAC automatically increases or the power decreases to stabilize LED brightness or to ballast the DC LED lights.

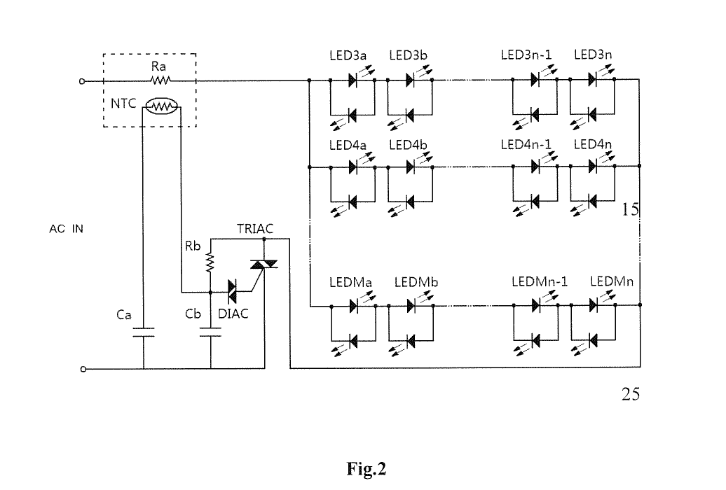

In a second embodiment, as shown in FIG. 2, when using AC lights in TRIAC-ballasted LED light and starting a power supply, electric current of the AC lights (are comprised of diodes LED3a, LED4a, and LEDMa) passes through a heat sensing module (indicated by a square dotted line in FIG. 2) which is comprised of a current limiting resistor Ra and a thermistor NTC, wherein the thermistor NTC is adhered on the current limiting resistor Ra by ways of a thermal conductive adhesive or is welded on adjacent copper foils by means of a SMD thermistor NTC and a SMD current limiting resistor Ra, such that the more electric current passing through the current limiting resistor Ra is, the higher the heat produces, and an impedance of the thermistor NTC becomes small, wherein a first Ceramic capacitor Ca connects with the thermistor NTC, and a second Ceramic capacitor Cb and a resistor Rb couple with a power conditioning circuit (is comprised of the second Ceramic capacitor Cb, the resistor Rb, the DIAC, and the TRIAC) so as to prolong a RC charging/discharging time, and a phase of the DIAC for triggering TRIAC automatically increases or the power decreases so as to stabilize LED brightness or to ballast the ACLED lights.

Referring to FIG. 1, in operation, after the power supply is conducted, the more the electric current passing through the current limiting resistor Ra is, the higher the heat produces so as to decrease the impedance of the thermistor NTC, wherein the first Ceramic capacitor Ca connects with the thermistor NTC, and the second Ceramic capacitor Cb couples with the power conditioning circuit (is comprised of the second Ceramic capacitor Cb, the resistor Rb, the DIAC, and the TRIAC) so as to enhance capacity in a parallel connecting manner, to prolog the RC charging/discharging time, and to lag the phase of the DIAC, thus lowering the power. When the power reduces and the electric current passing through the current limiting resistor Ra decreases, a lower heat produces and the impedance of the thermistor NTC amplifies, the first Ceramic capacitor Ca connects with the thermistor NTC, and the second Ceramic capacitor Cb parallelly couples with the power conditioning circuit (is comprised of the second Ceramic capacitor Cb, the resistor Rb, the DIAC, and the TRIAC) so as to lower the capacity, to shorten the RC charging/discharging time, to forward the phase of the DIAC and to enhance power. Thereby, the power can be increased or decreased automatically to stabilize LED brightness or to ballast the DC LED lights.

Since the TRIAC-ballasted LED light is simplified, i.e., electrolytic capacitors, transformers, inductors and chips are eliminated, so a failure rate is much lower than conventional switch-mode drive LED lights. Furthermore, high brightness, long service life, less operating current, lower cost, high reliability are achieved.

Preferably, a number of the LED lights is increased or decreased based on required brightness and power voltage. While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A LED light with TRIAC ballasted comprising:
a thermistor, Ceramic capacitors, resistors, DIAC, TRIAC, bridge rectifiers, and LED lights; characterized in that the LED lights include a heat sensing module which is comprised of the thermistor and the resistors, and a power conditioning circuit is comprised of the Ceramic capacitors, the resistors, the DIAC, and the TRIAC which are electrically connected together, after the heat sensing module is serially coupled with the bridge rectifiers and the LED lights applied direct current or after the heat sensing module is serially coupled with the LED lights applied alternating current, the power conditioning circuit is connected with a mains supply; after conducting power supply, electric current passes through the resistors to produce heat and decrease an impedance of the thermistor, wherein a first Ceramic capacitor connects with the thermistor, and a second Ceramic capacitor couples with the power conditioning circuit so as to enhance capacity in a parallel connecting manner, to prolog RC charging/discharging time, and to lag a phase of the DIAC for triggering the TRIAC, thus lowering the power; when the power reduces and the electric current passing through the resistors decreases, a lower heat produces and the impedance of the thermistor NTC amplifies, the first Ceramic capacitor connects with the thermistor, and the second Ceramic capacitor parallelly couples with the power conditioning circuit so as to lower the capacity, to shorten the RC charging/discharging time, to forward the phase of the DIAC and to enhance the power, so the power is increased or decreased automatically to stabilize LED brightness or to ballast the LED lights.

2. The LED light as claimed in claim 1, wherein the thermistor is adhered on the resistors by ways of a thermal conductive adhesive or is welded on adjacent copper foils by means of a SMD thermistor and a SMD current limiting resistor, such that after the power supply is conducted, the heat and the impedance of the thermistor change, and then the RC charging/discharging time changes to forward or to lag the phase of the DIAC, thus lowering the power to stabilize LED brightness or to ballast the LED lights.
